(19) United States
(12) Patent Application Publication
(10) Pub. No.: US 2017/0255561 A1
(43) Pub. Date: Sep. 7, 2017

(54) TECHNOLOGIES FOR INCREASING ASSOCIATIVITY OF A DIRECT-MAPPED CACHE USING COMPRESSION

(71) Applicant: Intel Corporation, Santa Clara, CA (US)

(72) Inventors: Alaa R. Alameldeen, Hillsboro, OR (US); Rajat Agarwal, Beaverton, OR (US)

(21) Appl. No.: 15/062,824

(22) Filed: Mar. 7, 2016

(51) Int. Cl. G06F 12/08; G06F 3/06

(52) U.S. Cl. CPC G06F 12/0864; G06F 3/0604; G06F 3/0638; G06F 3/0673; G06F 2212/60

(57) ABSTRACT

Technologies for increasing associativity of a direct mapped cache using compression include an apparatus that includes a memory to store data blocks, a cache to store a subset of the data blocks in various of physical cache blocks, and a memory management unit (MMU). The MMU is to compress data blocks associated with locations of the main memory that are mapped to a physical cache block and write the compressed data blocks to the physical cache block if the combined size of the compressed blocks satisfies a threshold size. Other embodiments are also described and claimed.

### BACKGROUND

In a direct-mapped cache, each location in main memory maps to only one entry in the cache. By contrast, in an associative cache, each location in main memory can be cached in one of N locations in the cache. Such a cache is typically referred to as an N-way set associative cache. As compared to an associative cache, such as an N-way set associative cache, a direct-mapped cache provides fast access to data while requiring a relatively smaller amount of space for tags and lower power overhead. However, a direct-mapped cache may incur more conflict misses than an associative cache when more than one “hot line” (i.e., frequently accessed main memory locations) are mapped to the same entry in the direct-mapped cache, thereby reducing performance.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a compute device for increasing associativity of a direct-mapped cache using compression;

FIG. 2 is a simplified block diagram of at least one embodiment of an environment that may be established by the compute device of FIG. 1;

FIGS. 3 and 4 are a simplified flow diagram of at least one embodiment of a method for reading data that may be executed by the compute device of FIG. 1;

FIG. 5 is a simplified flow diagram of at least one embodiment of a method for writing data that may be executed by the compute device of FIG. 1; and

FIG. 6 is a simplified block diagram of example data blocks in compressed forms and uncompressed forms in a physical cache block of the compute device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

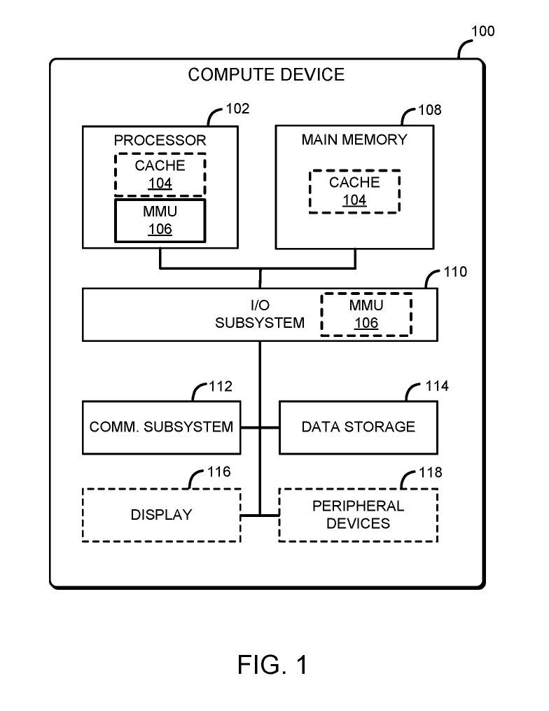

Referring now to FIG. 1, an illustrative compute device 100 for increasing associativity of direct-mapped cache using compression includes a processor 102, a direct-mapped cache 104, a memory management unit (MMU) 106, a main memory 108, and an input/output (I/O) subsystem 110. In use, as described in more detail herein, the MMU 106 of the compute device 100 is configured to compress multiple data blocks into a single physical cache block of the direct-mapped cache 104, thereby increasing the degrees of associativity (i.e., adding multiple “ways”) of the direct-mapped cache 104. In other words, the MMU 106 of the illustrative compute device 100 is configured to enable a direct-mapped cache, which typically is capable of storing only a single data block from the main memory 108 in a given physical cache block, to store multiple data blocks in a given physical cache block. As described in more detail herein, to enable identification of the requested data block, the illustrative compute device 100 may also be configured to store associated tags for each data block that is compressed into a given physical cache block. Accordingly, when a particular data block is requested from the cache 104, the cache is more likely to find the requested data block in the direct-mapped cache 104, thereby reducing the number of times the MMU 106 must read requested data blocks from the slower main memory 108.

The compute device 100 may be embodied as any type of compute device capable of performing the functions described herein. For example, in some embodiments, the compute device 100 may be embodied as, without limitation, a computer, a desktop computer, a workstation, a server computer, a laptop computer, a notebook computer, a tablet computer, a smartphone, a distributed computing system, a multiprocessor system, a consumer electronic device, a smart appliance, and/or any other computing device capable of compressing multiple data blocks into a physical cache block of a direct-mapped cache. As shown in FIG. 1, the illustrative compute device 100 includes the processor 102, the direct-mapped cache 104, the MMU 106, the main memory 108, the input/output (I/O) subsystem 110, a communication subsystem 112, and a data storage device 114. Of course, the compute device 100 may include other or additional components, such as those commonly found in a desktop computer (e.g., various input/output devices), in other embodiments. Additionally, in some embodiments, one or more of the illustrative components may be incorporated in, or otherwise from a portion of, another component. For example, the main memory 108, or portions thereof, may be incorporated in the processor 102 in some embodiments.

The processor 102 may be embodied as any type of processor capable of performing the functions described herein. For example, the processor may be embodied as a single or multi-core processor(s) having one or more processor cores, a digital signal processor, a microcontroller, or other processor or processing/controlling circuit. The direct-mapped cache 104 may be included in the processor 102, as processor-side cache. In other embodiments, the direct-mapped cache 104 may additionally or alternatively be included in the main memory 108, as memory-side cache. Further, in some embodiments, the cache 104 may include multiple levels, such as a level 1 (L1) cache, a level 2 (L2) cache, and a level 3 (L3) cache, such that lower levels (e.g., the L1 cache) are generally faster and smaller than higher levels (e.g., the L3 cache). In the illustrative embodiment, the MMU 106 is configured to read data blocks from the main memory 108, write data block to the main memory 108, and manage temporary storage of the data blocks in the cache 104 including compressing multiple data blocks into a single cache block, as described in more detail herein.

Similarly, the main memory 108 may be embodied as any type of volatile or non-volatile memory or data storage capable of performing the functions described herein. In operation, the main memory 108 may store various data and software used during operation of the compute device 100 such as operating systems, applications, programs, libraries, and drivers. As described above, in some embodiments, the cache 104 may be incorporated into the main memory 108, rather than or in addition to being incorporated in the processor 102.

Depending on the type and intended use of the compute device 100, the main memory 108 may be embodied as, or otherwise include, volatile memory which may be embodied as any type of memory capable of storing data while power is supplied to the volatile memory. For example, in the illustrative embodiment, the volatile memory may be embodied as one or more volatile memory devices, and is periodically referred to hereinafter as volatile memory with the understanding that the volatile memory may be embodied as other types of non-persistent data storage in other embodiments. The volatile memory devices of the volatile memory are illustratively embodied as dynamic random-access memory (DRAM) devices, but may be embodied as other types of volatile memory devices and/or memory technologies capable of storing data while power is supplied to the volatile memory.

The main memory 108 may additionally or alternatively be embodied as, or otherwise include, non-volatile memory which may be embodied as any type of memory capable of storing data in a persistent manner (even if power is interrupted to non-volatile memory). For example, in the illustrative embodiment, the non-volatile memory may be embodied as one or more non-volatile memory devices. For example, such non-volatile memory may be embodied as three dimensional NAND (“3D NAND”) non-volatile memory devices, memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or Spin Transfer Torque (STT)-MRAM.

The main memory 108 is communicatively coupled to the processor 102 via the I/O subsystem 110, which may be embodied as circuitry and/or components to facilitate input/output operations with the processor 102, the main memory 108, and other components of the compute device 100. For example, the I/O subsystem 110 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 110 may form a portion of a system-on-a-chip (SoC) and be incorporated, along with the processor 102, the main memory 108, and other components of the compute device 100, on a single integrated circuit chip. In some embodiments, the MMU 106, described above, may be incorporated into the I/O subsystem 110 rather than, or in addition to, being incorporated into the processor 102. For example, a memory controller of the compute device 100 (e.g., the MMU 106) can be in the same die or integrated circuit as the processor 102 or memory 108 or in a separate die or integrated circuit than those of the processor 102 and memory 108. In some cases, the processor 102, the memory controller, and the memory 108 can be implemented in a single die or integrated circuit.

The illustrative compute device 100 additionally includes the communication subsystem 112. The communication subsystem 112 may be embodied as one or more devices and/or circuitry for enabling communications with one or more remote devices over a network. The communication subsystem 112 may be configured to use any suitable communication protocol to communicate with other devices including, for example, wired data communication protocols, wireless data communication protocols, and/or cellular communication protocols.

The illustrative compute device 100 also includes the data storage device 114. The data storage device 114 may be embodied as any type of device or devices configured for short-term or long-term storage of data such as, for example, memory devices and circuits, memory cards, hard disk drives, solid-state drives, or other data storage devices.

The illustrative compute device 100 may also include a display 116, which may be embodied as any type of display on which information may be displayed to a user of the compute device 100. The display 116 may be embodied as, or otherwise use, any suitable display technology including, for example, a liquid crystal display (LCD), a light emitting diode (LED) display, a cathode ray tube (CRT) display, a plasma display, and/or other display usable in a compute device. Additionally, the display 116 may include a touchscreen sensor that uses any suitable touchscreen input technology to detect the user's tactile selection of information displayed on the display 116 including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors.

In some embodiments, the compute device 100 may further include one or more peripheral devices 118. Such peripheral devices 118 may include any type of peripheral device commonly found in a compute device such as speakers, a mouse, a keyboard, and/or other input/output devices, interface devices, and/or other peripheral devices.

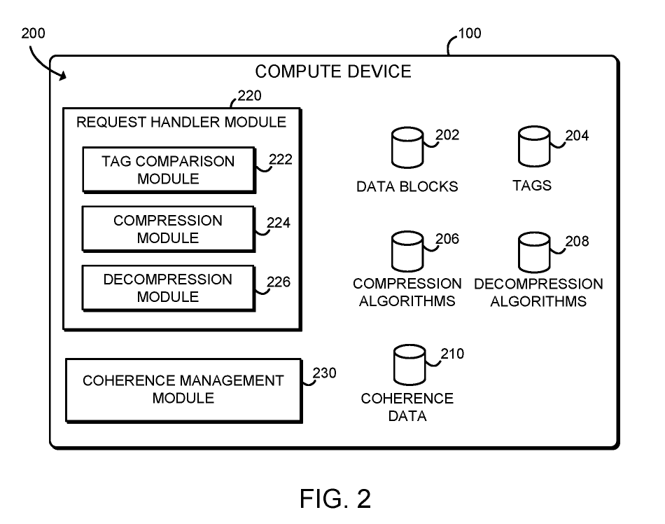

Referring now to FIG. 2, in use, the compute device 100 may establish an environment 200. The illustrative environment 200 includes a request handler module 220 and a coherence management module 230. Each of the modules and other components of the environment 200 may be embodied as firmware, software, hardware, or a combination thereof. For example the various modules, logic, and other components of the environment 200 may form a portion of, or otherwise be established by, the MMU 106 or other hardware components of the compute device 100. As such, in some embodiments, any one or more of the modules of the environment 200 may be embodied as a circuit or collection of electrical devices (e.g., a request handler circuit 220, a coherence management circuit 230, etc.). In the illustrative environment 200, the environment 200 includes data blocks 202, tags 204, compression algorithms 206, decompression algorithms 208, and coherence data 210, each of which may be accessed by the various modules and/or sub-modules of the compute device 100.

In the illustrative embodiment, the request handler module 220 is configured to handle requests to read or write data blocks and manage temporary storage and compression of the data blocks 202 in the direct-mapped cache 104. To do so, the request handler module 220 includes a tag comparison module 222, a compression module 224, and a decompression module 226. In the illustrative embodiment, the tag comparison module 222 is configured to identify a tag 204 included in an address of a read request or a write request, and compare the tag 204 to the tags 204 of one or more data blocks 202 stored at a physical cache block in the cache 104. As described above, a direct-mapped cache 104 is configured such that multiple main memory addresses are mapped to a single physical cache block. Accordingly, to distinguish a data block 202 associated with one main memory location versus a data block 202 associated with another main memory location that are both mapped to the same physical cache block, each data block 202 written to the cache is stored with a tag 204 that identifies which main memory location the data block 202 is associated with. As described above, in the illustrative embodiment, the tag comparison module 222 is configured to compare a tag 204 included in a read or write request to one or more tags 204 stored in the corresponding physical cache block to determine whether a matching data block 202 is stored in the physical cache block. If the tag comparison module 222 detects a match, a cache hit has occurred, and the request handler module 220 is configured to subsequently read the matching data block 202 associated with the matching tag 204 from the cache 104. Otherwise, a cache miss has occurred, and the request handler module 220 is configured to subsequently read the requested data block from the main memory 108.

In the illustrative embodiment, the compression module 224 is configured compress multiple data blocks 202 from main memory locations that are associated with the same physical cache block, such that the multiple data blocks are storable within the physical cache block concurrently. In the illustrative embodiment, the compression module 224 is configured to select a compression algorithm from a set of compression algorithms 206 to use in compressing the data blocks 202. For example, the compression module 224 may select one of the compression algorithms 206 based on a desired level of speed and/or compression to be obtained. In other embodiments, the compression module 224 may be configured to use a single compression algorithm 206. As described in more detail herein, in the illustrative embodiment, the request handler module 220 is configured to determine whether the combined (i.e., total) size of compressed data blocks 202 satisfies (e.g., is no greater than) a predefined threshold. If so, the request handler module 220 is configured to write the compressed data blocks 202 to the physical cache block. Otherwise, the request handler module 220 removes (i.e., evicts or allows overwriting) all data blocks 202 from the physical cache block except for the most recently accessed data block 202 (e.g., the data block to be presently written to the cache 104) and stores the most recent data block 202 in an uncompressed form. In determining whether the combined size is no greater than the threshold size, the request handler module 220 may be configured to compare the combined size to a total size of the physical cache block, minus an amount of space to be used for storage of the tags 204 associated with the data blocks 202.

The decompression module 226, in the illustrative embodiment, is configured to decompress a matching data block 202 from a physical cache block in response to a read request, after the tag comparison module 222 has determined that a matching tag has been identified. In the illustrative embodiment, the decompression module 226 is configured to select a decompression algorithm 208 that corresponds with the compression algorithm 206 that the compression module 224 used to compress the matching data block 202 previously. In some embodiments, the decompression module 226 may be configured to use a single decompression algorithm 208 rather than to select from multiple decompression algorithms 208.

In the illustrative embodiment, the coherence management module 230 is configured to generate and track coherence data 210 regarding data blocks in the cache 104. For example, in the illustrative embodiment, the coherence data 210 includes data regarding permissions associated with the modification of various data blocks 202 in the cache 104. The coherence management module 230 may be configured to prevent multiple processes from modifying the same data block 202 simultaneously. The coherence management module 230 may also track whether and which of the various data blocks 202 have been modified, such that modified data blocks 202 may be written to the main memory 108 prior to being removed (i.e., evicted or allowed to be overwritten) from the cache 104.

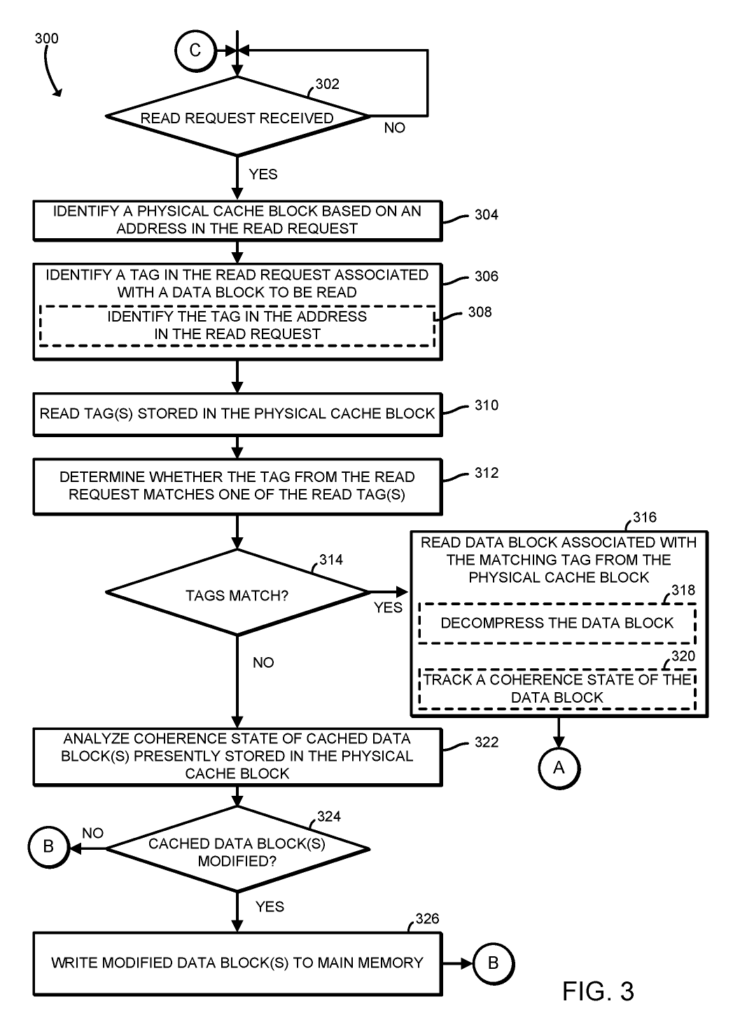

Referring now to FIG. 3, in use, the compute device 100 may execute a method 300 for reading data and potentially compressing multiple data blocks 202 into a single physical cache block so as to increase the associativity of the direct-mapped cache 104 (e.g., so as to have at least two-way set associativity). In the illustrative embodiment, the method 300 may be executed by the MMU 106, but may be executed by the processor 102 or other components of the compute device 100 in other embodiments. The method 300 begins with block 302 in which the MMU 106 determines whether a read request has been received (e.g., from the processor 102). If a read request has been received, the method 300 advances to block 304, in which the MMU 106 identifies a physical cache block based on an address in the read request. In the illustrative embodiment, an address in a read request is associated with a main memory location. Further, as described above, the direct-mapped cache 104 is mapped such that, for a given physical cache block, multiple locations in the main memory may be mapped to that particular physical cache block. Accordingly, the MMU 106 may determine the physical cache block based on the address in the request. In block 306, the MMU 106 identifies a tag 204 in the read request. The tag 204 is associated with (i.e., identifies) the particular data block 202 within the identified physical cache block to be read. As indicated in block 308, in the illustrative embodiment, the MMU 106 may identify the tag 204 in the address that is included in the read request. In other words, the tag 204 may be a component (e.g., a subset of the bits) of the address included in the read request. In block 310, the MMU 106 reads one or more tags 204 stored in the physical cache block that was identified in block 304. In the illustrative embodiment, the tags 204 are not stored in a compressed form. Rather, the tags 204 are stored in an uncompressed form to reduce the overhead (i.e., processing time) in reading the tags 204. In another embodiment, the tags 204 are stored in compressed form.

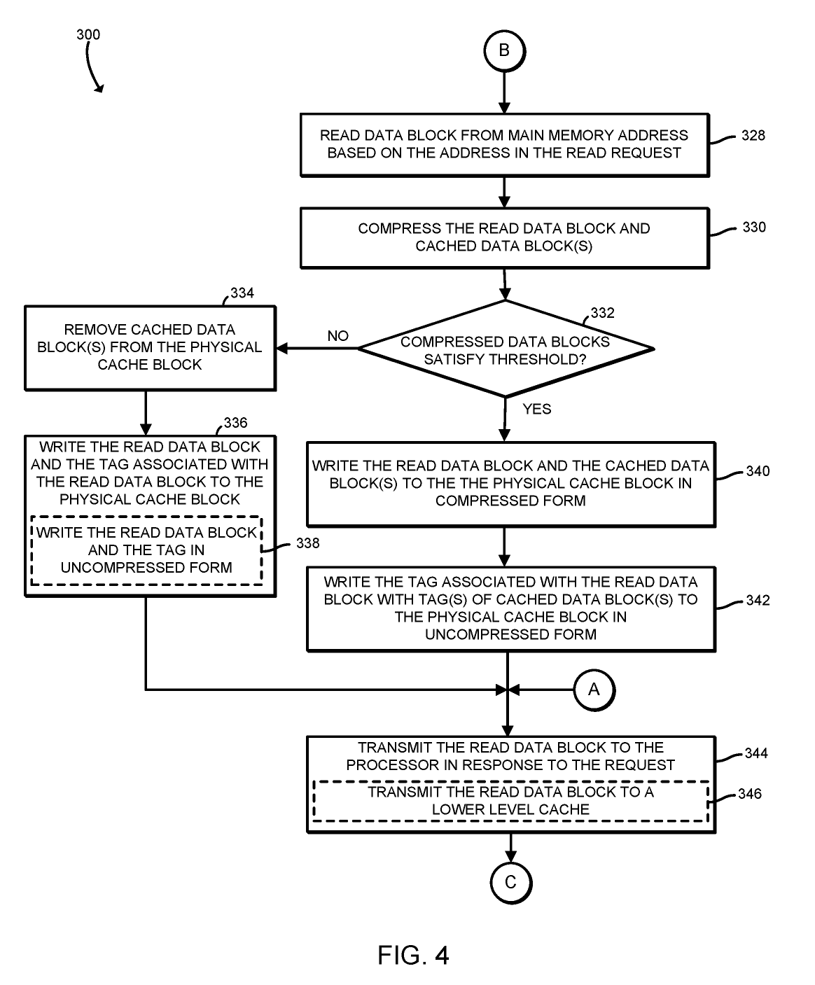

In block 312, the MMU 106 determines whether the tag from the read request matches (e.g., is equal to) one of the tags that were read in block 310. In the illustrative embodiment, the MMU 106 may compare the tags 204 stored in the physical cache block to the tag 204 from the read request until the MMU 106 finds a match or until all of the tags 204 have been compared. In block 314, the MMU 106 determines whether one of the tags 204 from the identified physical cache block matches the tag 204 in the read request. If so, the method 300 advances to block 316 in which the MMU 106 reads the data block 202 associated with the matching tag 204 from the identified physical cache block. In doing so, as indicated in block 318, the MMU 106 may decompress the matching data block 204 if the matching data block 204 is compressed with other data blocks 202 in the physical cache block. Further, the MMU 106 may track a coherence state of the data block 202 read from the physical cache block. For example, in the illustrative embodiment, the MMU 106 may configure coherence management circuitry to track whether and when the read data block 202 is subsequently modified by a process. The method 300 subsequently advances to block 344 of FIG. 4 to transmit the read data block 202 to the processor 102 in response to the request, as described in more detail herein.

Referring back to block 314 of FIG. 3, if the MMU 106 instead determines that the tags do not match, the method 300 advances to block 322 in which the MMU 106 analyzes a coherence state of one or more cached data blocks 202 that are presently stored in the physical cache block. As described above, in the illustrative embodiment, the coherence state indicates whether a data block 202 has been modified so that a version of the data block 202 stored in the cache is different than a version stored in the main memory 108. In block 324, the MMU 106 determines whether any of the cached data blocks 202 have been modified. If the MMU 106 determines that one or more of the cached data blocks 202 have been modified, the method 300 advances to block 326 in which the MMU 106 writes the modified one or more data blocks 202 to the main memory 108. Subsequently, or if the MMU 106 determines that none of the cached data blocks 202 have been modified in block 324, the method advances to block 328 of FIG. 4, in which the MMU 106 reads the data block 202 from the main memory address based on the address in the read request. In other words, given that the MMU 106 did not find the requested data block in the cache 104 (i.e., a cache miss), the MMU 106 reads the requested data block from the main memory 108, at a location associated with the address specified in the read request.

In block 330, the MMU 106 compresses the read data block 202 and the one or more cached data blocks 202 that are presently stored at the identified physical cache block. To do so, the MMU 106 may utilize any suitable compression algorithm or methodology to compress the data blocks. In block 332, the MMU 106 determines whether the combined size of the compressed data blocks (i.e., the compressed size of the read data block plus the compressed size of the already-cached data blocks) satisfies a threshold size. In the illustrative embodiment, the threshold size is the size of the physical cache block, minus an amount of space (e.g., number of bytes) to be reserved for storage of tags 204. In the illustrative embodiment, the total size of the physical cache block is defined as 66 bytes and each tag 204 is defined as two bytes in size. As should be appreciated, as the number of compressed data blocks to be stored in the physical cache block increases, the number of tags to be stored in the physical cache block also increases and the physical cache block can be other sizes. If the MMU 106 determines that the combined size of the compressed data blocks does not satisfy the threshold size, the method 300 advances to block 334 in which the MMU 106 removes (i.e., evicts or allows overwriting) the one or more cached data blocks 202 from the physical cache block, thereby providing space to write the data block 202 that was read from the main memory 108 in block 328. In block 336, the MMU 106 writes the read data block 202 and the tag 204 (i.e., the tag from the read request) associated with the read data block 202 to the physical cache block, overwriting at least a portion of the cached data blocks. In doing so, the MMU 106 may write the read data block 202 and the tag 204 in an uncompressed form, as indicated in block 338. In other words, given that the other cached blocks have been evicted from the physical cache block, the read data block 202 and its tag 204 are storable in the physical cache block without being compressed.

Referring back to block 332, if the MMU 106 instead determines that the combined size of the compressed data blocks 202 satisfies the threshold (e.g., is less than or equal to the threshold), the method 300 advances to block 340 in which the MMU 106 writes the read data block 202 and the one or more cached data blocks 202 to the physical cache block in compressed form. In block 342, the MMU 106 writes the tag 204 associated with the read data block 202 and the tags 204 of the one or more already cached data blocks 202 to the physical cache block in an uncompressed form. Writing the tags 204 in an uncompressed form is advantageous because it allows the MMU 106 to more quickly read and compare the tags 204 to a reference tag 204 (i.e., a tag from a read or write request) than if the tags 204 were written in a compressed form and required decompression prior to being read. Other embodiments may write the tags 204 in compressed form. In block 344, the MMU 106 transmits the read data block 202 to the processor 102 in response to the read request. The MMU 106 may also transmit the read data block to a lower level cache for storage therein, as indicated in block 346.

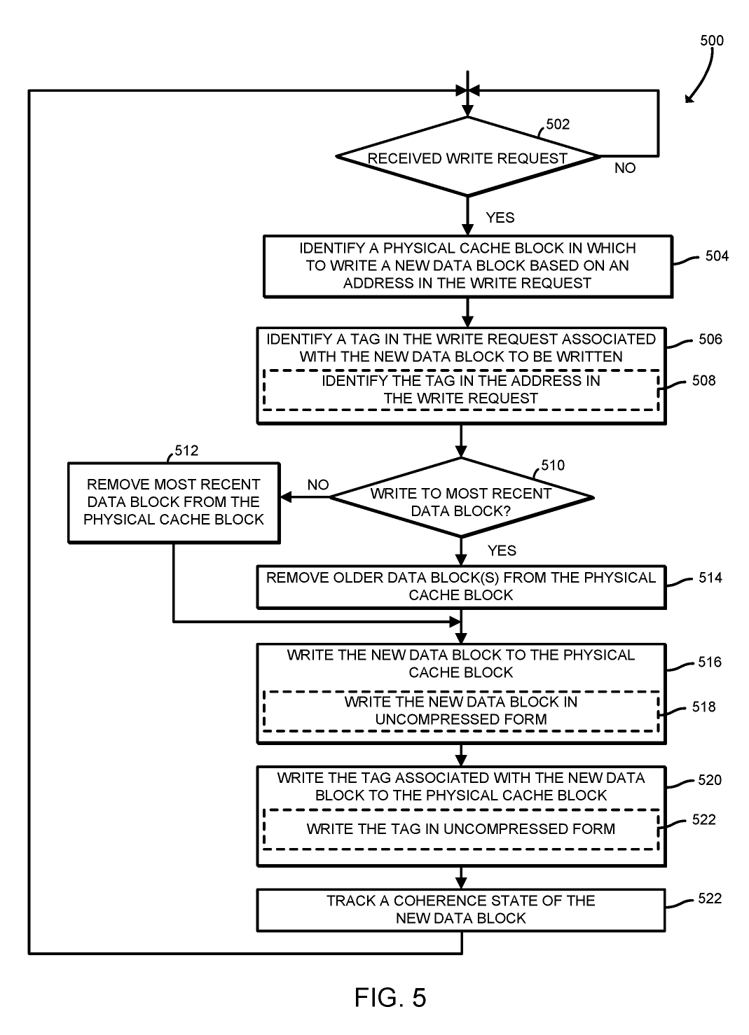

Referring now to FIG. 5, in use, the compute device 100 may execute a method 500 for writing data to the cache 104. In the illustrative embodiment, the method 500 may be executed by the MMU 106, but may be executed by the processor 102 or other components of the compute device 100 in other embodiments. The method 500 begins with block 502 in which the MMU 106 determines whether a write request has been received (e.g., from the processor 102). If a write request has been received, the method 500 advances to block 504 in which the MMU 106 identifies a physical cache block in which to write a data block 202 based on an address included in the write request. As described above, each physical cache block in the direct-mapped cache 104 can be mapped to multiple locations in the main memory 108. The address in the write request specifies one of the locations of the main memory 108 and the MMU 106 determines which physical cache block that address is mapped to, such as by referencing a lookup table. In block 506, the MMU 106 identifies a tag 204 in the write request associated with the new data block 202 to be written. In the illustrative embodiment, the tag 204 is embodied as a subset of the bits in the address of the write request. Accordingly, as indicated in block 508, the illustrative MMU 106 may identify the tag 204 in the address associated with the write request.

In block 510, the MMU 106 determines whether the tag 204 corresponds to a tag 204 of the most recent data block 202 that was written to the identified physical cache block (i.e., the “fill line”). If not, the method 500 advances to block 512, in which the MMU 106 removes (i.e., evicts or allows overwriting) the most recent data block 202 (i.e., the “fill line”) from the physical cache block. Referring back to block 510, if the tag 204 does match the tag of the most recent data block 202, the method 500 advances to block 514 in which the MMU 106 removes (i.e., evicts or allows overwriting) the one or more older data blocks 202 (i.e., the “victim line(s)”) from the physical cache block. In block 516, the MMU 106 writes the new data block 202 to the physical cache block that was identified in block 504, overwriting at least a portion of any evicted data blocks 202. In doing so, as indicated in block 518, the MMU 106 may write the new data block 202 in an uncompressed form, such as if the new data block 202 is to be the only data block in the physical data block (i.e., the other data blocks have been removed). In block 520, the MMU 106 writes the tag 204 associated with the new data block 202 to the physical cache block. As indicated in block 522, in the illustrative embodiment, the MMU 106 may write the tag 204 in an uncompressed form. As described above, writing tags 204 in an uncompressed form reduces the overhead in reading the tags 204 at a later point in time because the tags 204 need not be decompressed in order to read them. In block 522, the MMU 106 tracks a coherence state of the new data block 202 to determine if and when the data block 202 is modified by the process. By tracking the coherence state, the MMU 106 may later determine whether the data block 202 should be written back to the main memory 108 before it is removed (i.e., evicted or allowed to be overwritten) from the cache 104 (i.e., to provide space in the physical cache block for another data block 202).

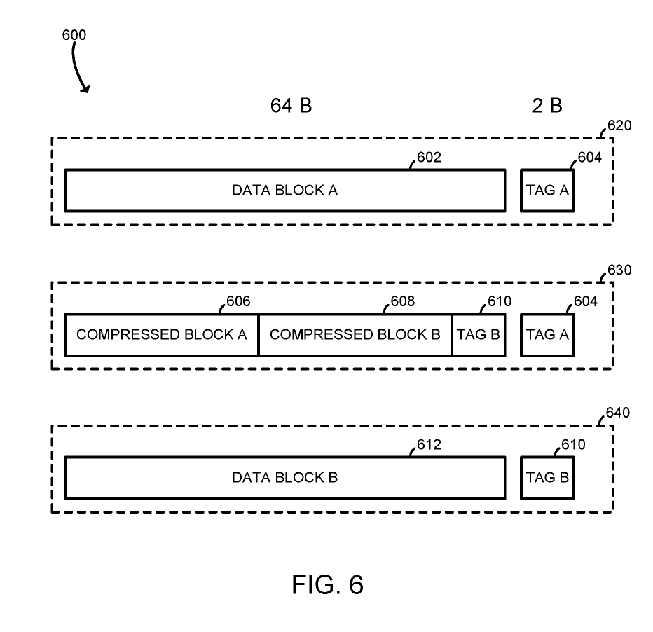

Referring now to FIG. 6, a physical cache block 600 of the direct-mapped cache 104 may store a cached data block 602 and an associated tag 604 in one configuration 620. Referring back to the method 300, if the MMU 106 determines that a cache miss has occurred and subsequently reads a data block from the main memory 108, the MMU 106 may compress the cached data block 602 and the read data block 612 into compressed blocks 606, 608 and determine whether the compressed blocks 606, 608 have a combined size that satisfies a threshold size. In the illustrative embodiment, the physical cache block 600 may have a size of 66 bytes, with 64 bytes for data and 2 bytes for a tag. Additionally, in the illustrative embodiment, each tag may be two bytes in size. Accordingly, in the illustrative embodiment, the threshold size for storing two compressed data blocks may be 62 bytes. If the combined size meets the threshold size, MMU 106 may write the compressed blocks 606, 608 and their associated tags 604, 610 to the physical cache block 600 in a compressed configuration 630. However, as shown in another configuration 640 of the data in the physical cache block 600, if the combined size of the compressed blocks does not satisfy the threshold size, the MMU 106 may remove (i.e., evict or allow to overwrite) the data block 602 and the corresponding tag 604 from the physical cache block 600 and write the read data block 612 in an uncompressed form with the corresponding tag 610 to the physical cache block 600.

Reference to memory devices herein can apply to different memory types, and in particular, any memory that has a bank group architecture. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR4 (DDR version 4, initial specification published in September 2012 by JEDEC), DDR4E (in development by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDRS (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

In addition to, or alternatively to, volatile memory, in one embodiment, reference to memory devices can refer to a nonvolatile memory device whose state is determinate even if power is interrupted to the device.

### EXAMPLES

Illustrative examples of the technologies disclosed herein are provided below. An embodiment of the technologies may include any one or more, and any combination of, the examples described below.

Example 1 includes an apparatus comprising a memory to store data blocks; a cache to store a subset of the data blocks in a plurality of physical cache blocks; and a memory management unit (MMU) to identify, in response to a read request, a physical cache block based on an address in the read request for a requested data block; determine whether the requested data block is stored in the physical cache block; read, in response to a determination that the requested data block is not stored in the physical cache block, the requested data block from the memory; compress a cached data block presently stored in the physical cache block; compress the read data block; determine whether a combined size of the compressed cached data block and the compressed read data block satisfies a threshold size; and store, in response to a determination that the combined size of the compressed data block and the compressed read data block satisfies the threshold size, the compressed cached data block and the compressed read data block in the physical cache block.

Example 2 includes the subject matter of Example 1, and wherein to determine whether the combined size satisfies the threshold size comprises to determine whether the combined size is not greater than a size of the physical cache block.

Example 3 includes the subject matter of any of Examples 1 and 2, and wherein to determine whether the requested data block is stored in the physical cache block comprises identify a tag in the read request; and compare the tag in the read request to a tag stored in the physical cache block in association with the cached data block.

Example 4 includes the subject matter of any of Examples 1-3, and wherein the MMU is further to determine whether the cached data block has been modified; and write, in response to a determination that the cached data block has been modified, the cached data block to the memory before compressions of the cached data block and the read data block.

Example 5 includes the subject matter of any of Examples 1-4, and wherein the MMU is further to store a first tag associated with the cached data block and a second tag associated with the read data block in the physical cache block.

Example 6 includes the subject matter of any of Examples 1-5, and wherein the read request is a first read request and the MMU is further to identify a tag in a second read request; determine whether the tag from the second read request matches a first tag stored in the physical cache block in association with the cached data block or a second tag stored in the physical cache block in association with the read data block; identify, in response to a determination that one of the first tag and the second tag matches the tag in the second read request, an associated one of the cached data block and the read data block as a matched data block; and decompress the matched data block from the physical cache block in response to the second read request.

Example 7 includes the subject matter of any of Examples 1-6, and wherein the MMU is further to track a coherence state of the matched data block after the matched data block is decompressed from the physical cache block.

Example 8 includes the subject matter of any of Examples 1-7, and wherein the MMU is further to in response to a determination that the combined size does not satisfy the threshold size, write the read data block over at least a portion of the cached data block in the physical cache block.

Example 9 includes the subject matter of any of Examples 1-8, and wherein to write the read data block to the physical cache block comprises to write the read data block in an uncompressed form.

Example 10 includes the subject matter of any of Examples 1-9, and wherein the MMU is further to determine, in response to a write request, whether a tag included in the write request is equal to a first tag stored in the physical cache block in association with the cached data block or a second tag stored in the physical cache block in association with the read data block; and in response to a determination that the tag included in the write request is equal to the second tag, write a new data block included in the write request to the physical cache block in an uncompressed form over at least a portion of the cached data block stored in the physical cache block.

Example 11 includes the subject matter of any of Examples 1-10, and wherein the MMU is further to track a coherence state of the new data block after the new data block is written to the physical cache block.

Example 12 includes the subject matter of any of Examples 1-11, and wherein the MMU is further to determine, in response to a write request, whether a tag included in the write request matches a first tag stored in the physical cache block in association with the cached data block or a second tag stored in the physical cache block in association with the read data block; and in response to a determination that the tag included in the write request matches the first tag, write a new data block included in the write request to the physical cache block in an uncompressed form over at least a portion of the cached data block stored in the physical cache block.

Example 13 includes the subject matter of any of Examples 1-12, and wherein the MMU is further to track a coherence state of the new data block after the new data block is written to the physical cache block.

Example 14 includes the subject matter of any of Examples 1-13, and wherein the cache is included in the memory.

Example 15 includes the subject matter of any of Examples 1-14, and wherein the cache is included in the processor.

Example 16 includes the subject matter of any of Examples 1-15, and wherein the cache is a direct mapped cache.

Example 17 includes the subject matter of any of Examples 1-16, and further including a processor, wherein the MMU is included in the processor.

Example 18 includes the subject matter of any of Examples 1-17, and further including an input/output (I/O) subsystem, wherein the MMU is included in the I/O subsystem.

Example 19 includes the subject matter of any of Examples 1-18, and further including one or more of one or more processors communicatively coupled to the memory; a display device communicatively coupled to a processor; a network interface communicatively coupled to a processor; or a battery coupled to the apparatus.

Example 20 includes a method comprising identifying, by a memory management unit (MMU) of an apparatus and in response to a read request, a physical cache block in a cache based on an address in the read request for a requested data block; determining, by the MMU, whether the requested data block is stored in the physical cache block; reading, by the MMU, in response to a determination that the requested data block is not stored in the physical cache block, the requested data block from a memory; compressing, by the MMU, a cached data block presently stored in the physical cache block; compress the read data block; determining, by the MMU, whether a combined size of the compressed cached data block and the compressed read data block satisfies a threshold size; and storing, by the MMU and in response to a determination that the combined size of the compressed data block and the compressed read data block satisfies the threshold size, the compressed cached data block and the compressed read data block in the physical cache block.

Example 21 includes the subject matter of Example 20, and wherein determining whether the combined size satisfies the threshold size comprises determining whether the combined size is not greater than a size of the physical cache block.

Example 22 includes the subject matter of any of Examples 20 and 21, and wherein determining whether the requested data block is stored in the physical cache block comprises: identifying, by the MMU, a tag in the read request; and comparing, by the MMU, the tag in the read request to a tag stored in the physical cache block in association with the cached data block.

Example 23 includes the subject matter of any of Examples 20-22, and further including determining, by the MMU, whether the cached data block has been modified; and writing, by the MMU and in response to a determination that the cached data block has been modified, the cached data block to the memory before compressions of the cached data block and the read data block.

Example 24 includes the subject matter of any of Examples 20-23, and further including storing a first tag associated with the cached data block and a second tag associated with the read data block in the physical cache block.

Example 25 includes the subject matter of any of Examples 20-24, and wherein the read request is a first read request, the method further comprising identifying, by the MMU, a tag in a second read request; determining, by the MMU, whether the tag from the second read request matches a first tag stored in the physical cache block in association with the cached data block or a second tag stored in the physical cache block in association with the read data block; identifying, by the MMU and in response to a determination that one of the first tag and the second tag matches the tag in the second read request, an associated one of the cached data block and the read data block as a matched data block; and decompressing, by the MMU, the matched data block from the physical cache block in response to the second read request.

Example 26 includes the subject matter of any of Examples 20-25, and further including tracking, by the MMU, a coherence state of the matched data block after the matched data block is decompressed from the physical cache block.

Example 27 includes the subject matter of any of Examples 20-26, and further including writing, by the MMU and in response to a determination that the combined size does not satisfy the threshold size, the read data block over at least a portion of the cached data block in the physical cache block.

Example 28 includes the subject matter of any of Examples 20-27, and wherein writing the read data block to the physical cache block comprises writing the read data block in an uncompressed form.

Example 29 includes the subject matter of any of Examples 20-28, and further including determining, by the MMU and in response to a write request, whether a tag included in the write request is equal to a first tag stored in the physical cache block in association with the cached data block or a second tag stored in the physical cache block in association with the read data block; writing, by the MMU and in response to a determination that the tag included in the write request is equal to the second tag, a new data block included in the write request to the physical cache block in an uncompressed form over at least a portion of the cached data block stored in the physical cache block.

Example 30 includes the subject matter of any of Examples 20-29, and further including tracking, by the MMU, a coherence state of the new data block after the new data block is written to the physical cache block.

Example 31 includes the subject matter of any of Examples 20-30, and further including determining, by the MMU and in response to a write request, whether a tag included in the write request matches a first tag stored in the physical cache block in association with the cached data block or a second tag stored in the physical cache block in association with the read data block; writing, by the MMU and in response to a determination that the tag included in the write request matches the first tag, a new data block included in the write request to the physical cache block in an uncompressed form over at least a portion of the cached data block stored in the physical cache block.

Example 32 includes the subject matter of any of Examples 20-31, and further including tracking, by the MMU, a coherence state of the new data block after the new data block is written to the physical cache block.

Example 33 includes one or more machine-readable storage media comprising a plurality of instructions stored thereon that, when executed, cause an apparatus to perform the method of any of Examples 20-32.

Example 34 includes an apparatus comprising means for identifying, in response to a read request, a physical cache block in a cache based on an address in the read request for a requested data block; means for determining whether the requested data block is stored in the physical cache block; means for reading, in response to a determination that the requested data block is not stored in the physical cache block, the requested data block from a memory; means for compressing a cached data block presently stored in the physical cache block; means for compressing the read data block; means for determining whether a combined size of the compressed cached data block and the compressed read data block satisfies a threshold size; and means for storing, in response to a determination that the combined size of the compressed data block and the compressed read data block satisfies the threshold size, the compressed cached data block and the compressed read data block in the physical cache block.

Example 35 includes the subject matter of Example 34, and wherein the means for determining whether the combined size satisfies the threshold size comprises means for determining whether the combined size is not greater than a size of the physical cache block.

Example 36 includes the subject matter of any of Examples 34 and 35, and wherein the means for determining whether the requested data block is stored in the physical cache block comprises means for identifying a tag in the read request; and means for comparing the tag in the read request to a tag stored in the physical cache block in association with the cached data block.

Example 37 includes the subject matter of any of Examples 34-36, and further including means for determining whether the cached data block has been modified; and means for writing, in response to a determination that the cached data block has been modified, the cached data block to the memory before compressions of the cached data block and the read data block.

Example 38 includes the subject matter of any of Examples 34-37, and further including means for storing a first tag associated with the cached data block and a second tag associated with the read data block in the physical cache block.

Example 39 includes the subject matter of any of Examples 34-38, and wherein the read request is a first read request, the apparatus further comprising means for identifying a tag in a second read request; means for determining whether the tag from the second read request matches a first tag stored in the physical cache block in association with the cached data block or a second tag stored in the physical cache block in association with the read data block; means for identifying, in response to a determination that one of the first tag and the second tag matches the tag in the second read request, an associated one of the cached data block and the read data block as a matched data block; and means for decompressing, in response to the second read request, the matched data block from the physical cache block.

Example 40 includes the subject matter of any of Examples 34-39, and further including means for tracking a coherence state of the matched data block after the matched data block is decompressed from the physical cache block.

Example 41 includes the subject matter of any of Examples 34-40, and further including means for writing, in response to a determination that the combined size does not satisfy the threshold size, the read data block over at least a portion of the cached data block in the physical cache block.

Example 42 includes the subject matter of any of Examples 34-41, and wherein the means for writing the read data block to the physical cache block comprises means for writing the read data block in an uncompressed form.

Example 43 includes the subject matter of any of Examples 34-42, and further including means for determining, in response to a write request, whether a tag included in the write request is equal to a first tag stored in the physical cache block in association with the cached data block or a second tag stored in the physical cache block in association with the read data block; means for writing, in response to a determination that the tag included in the write request is equal to the second tag, a new data block included in the write request to the physical cache block in an uncompressed form over at least a portion of the cached data block stored in the physical cache block.

Example 44 includes the subject matter of any of Examples 34-43, and further including means for tracking a coherence state of the new data block after the new data block is written to the physical cache block.

Example 45 includes the subject matter of any of Examples 34-44, and further including means for determining, in response to a write request, whether a tag included in the write request matches a first tag stored in the physical cache block in association with the cached data block or a second tag stored in the physical cache block in association with the read data block; means for writing, in response to a determination that the tag included in the write request matches the first tag, a new data block included in the write request to the physical cache block in an uncompressed form over at least a portion of the cached data block stored in the physical cache block.

Example 46 includes the subject matter of any of Examples 34-45, and further including means for tracking a coherence state of the new data block after the new data block is written to the physical cache block.

1. An apparatus comprising:
a memory to store data blocks;
a cache to store a subset of the data blocks in a plurality of physical cache blocks; and
a memory management unit (MMU) to:
identify, in response to a read request, a physical cache block based on an address in the read request for a requested data block;
determine whether the requested data block is stored in the physical cache block;
read, in response to a determination that the requested data block is not stored in the physical cache block, the requested data block from the memory;
compress a cached data block presently stored in the physical cache block;
compress the read data block;
determine whether a combined size of the compressed cached data block and the compressed read data block satisfies a threshold size; and
store, in response to a determination that the combined size of the compressed data block and the compressed read data block satisfies the threshold size, the compressed cached data block and the compressed read data block in the physical cache block.

2. The apparatus of claim 1, wherein to determine whether the combined size satisfies the threshold size comprises to determine whether the combined size is not greater than a size of the physical cache block.

3. The apparatus of claim 1, wherein to determine whether the requested data block is stored in the physical cache block comprises:
identify a tag in the read request; and
compare the tag in the read request to a tag stored in the physical cache block in association with the cached data block.

4. The apparatus of claim 1, wherein the MMU is further to:
determine whether the cached data block has been modified; and
write, in response to a determination that the cached data block has been modified, the cached data block to the memory before compressions of the cached data block and the read data block.

5. The apparatus of claim 1, wherein the MMU is further to store a first tag associated with the cached data block and a second tag associated with the read data block in the physical cache block.

6. The apparatus of claim 1, wherein the read request is a first read request and the MMU is further to:
identify a tag in a second read request;
determine whether the tag from the second read request matches a first tag stored in the physical cache block in association with the cached data block or a second tag stored in the physical cache block in association with the read data block;
identify, in response to a determination that one of the first tag and the second tag matches the tag in the second read request, an associated one of the cached data block and the read data block as a matched data block; and
decompress the matched data block from the physical cache block in response to the second read request.

7. The apparatus of claim 6, wherein the MMU is further to track a coherence state of the matched data block after the matched data block is decompressed from the physical cache block.

8. The apparatus of claim 1, wherein the MMU is further to:
in response to a determination that the combined size does not satisfy the threshold size, write the read data block over at least a portion of the cached data block in the physical cache block.

9. The apparatus of claim 8, wherein to write the read data block to the physical cache block comprises to write the read data block in an uncompressed form.

10. The apparatus of claim 1, wherein the MMU is further to:
determine, in response to a write request, whether a tag included in the write request is equal to a first tag stored in the physical cache block in association with the cached data block or a second tag stored in the physical cache block in association with the read data block; and
in response to a determination that the tag included in the write request is equal to the second tag, write a new data block included in the write request to the physical cache block in an uncompressed form over at least a portion of the cached data block stored in the physical cache block.

11. The apparatus of claim 10, wherein the MMU is further to track a coherence state of the new data block after the new data block is written to the physical cache block.

12. The apparatus of claim 1, wherein the MMU is further to:
determine, in response to a write request, whether a tag included in the write request matches a first tag stored in the physical cache block in association with the cached data block or a second tag stored in the physical cache block in association with the read data block; and
in response to a determination that the tag included in the write request matches the first tag, write a new data block included in the write request to the physical cache block in an uncompressed form over at least a portion of the cached data block stored in the physical cache block.

13. The apparatus of claim 1, further comprising one or more of:
one or more processors communicatively coupled to the memory;
a display device communicatively coupled to a processor;
a network interface communicatively coupled to a processor; or
a battery coupled to the apparatus.

14. One or more machine-readable storage media comprising a plurality of instructions stored thereon that, when executed, cause an apparatus to:
identify, in response to a read request, a physical cache block in a cache based on an address in the read request for a requested data block;
determine whether the requested data block is stored in the physical cache block;
read, in response to a determination that the requested data block is not stored in the physical cache block, the requested data block from a memory;
compress a cached data block presently stored in the physical cache block;
compress the read data block;
determine whether a combined size of the compressed cached data block and the compressed read data block satisfies a threshold size; and
store, in response to a determination that the combined size of the compressed data block and the compressed read data block satisfies the threshold size, the compressed cached data block and the compressed read data block in the physical cache block.

15. The one or more machine-readable storage media of claim 14, wherein to determine whether the combined size satisfies the threshold size comprises to determine whether the combined size is not greater than a size of the physical cache block.

16. The one or more machine-readable storage media of claim 14, wherein to determine whether the requested data block is stored in the physical cache block comprises:
identify a tag in the read request; and
compare the tag in the read request to a tag stored in the physical cache block in association with the cached data block.

17. The one or more machine-readable storage media of claim 14, wherein the plurality of instructions, when executed, further cause the apparatus to:
determine whether the cached data block has been modified; and
write, in response to a determination that the cached data block has been modified, the cached data block to the memory before compressions of the cached data block and the read data block.

18. The one or more machine-readable storage media of claim 14, wherein the plurality of instructions, when executed, further cause the apparatus to store a first tag associated with the cached data block and a second tag associated with the read data block in the physical cache block.

19. The one or more machine-readable storage media of claim 14, wherein the read request is a first read request and the plurality of instructions, when executed, further cause the apparatus to:
identify a tag in a second read request;
determine whether the tag from the second read request matches a first tag stored in the physical cache block in association with the cached data block or a second tag stored in the physical cache block in association with the read data block;
identify, in response to a determination that one of the first tag and the second tag matches the tag in the second read request, an associated one of the cached data block and the read data block as a matched data block; and
decompress the matched data block from the physical cache block in response to the second read request.

20. The one or more machine-readable storage media of claim 19, wherein the plurality of instructions, when executed, further cause the apparatus to track a coherence state of the matched data block after the matched data block is decompressed from the physical cache block.

21. A method comprising:
identifying, by a memory management unit (MMU) of an apparatus and in response to a read request, a physical cache block in a cache based on an address in the read request for a requested data block;
determining, by the MMU, whether the requested data block is stored in the physical cache block;
reading, by the MMU, in response to a determination that the requested data block is not stored in the physical cache block, the requested data block from a memory;
compressing, by the MMU, a cached data block presently stored in the physical cache block;
compressing, by the MMU, the read data block;
determining, by the MMU, whether a combined size of the compressed cached data block and the compressed read data block satisfies a threshold size; and
storing, by the MMU and in response to a determination that the combined size of the compressed data block and the compressed read data block satisfies the threshold size, the compressed cached data block and the compressed read data block in the physical cache block.

22. The method of claim 21, wherein determining whether the combined size satisfies the threshold size comprises determining whether the combined size is not greater than a size of the physical cache block.

23. The method of claim 21, wherein determining whether the requested data block is stored in the physical cache block comprises:
identifying, by the MMU, a tag in the read request; and
comparing, by the MMU, the tag in the read request to a tag stored in the physical cache block in association with the cached data block.

24. The method of claim 21, further comprising:
determining, by the MMU, whether the cached data block has been modified; and
writing, by the MMU and in response to a determination that the cached data block has been modified, the cached data block to the memory before compressions of the cached data block and the read data block.

25. The method of claim 21, further comprising storing a first tag associated with the cached data block and a second tag associated with the read data block in the physical cache block.
